(19) United States
(12) Patent Application Publication
(10) Pub. No.: US 2026/0074445 A1
(43) Pub. Date: Mar. 12, 2026

(54) ASSEMBLY ENABLING CONNECTION TO VEHICLE MEDIA SYSTEM AND FAST CHARGING

(71) Applicant: Jared Melnicoff, Brooklyn, NY (US)

(72) Inventor: Jared Melnicoff, Brooklyn, NY (US)

(21) Appl. No.: 17/507,086

(22) Filed: Oct. 21, 2021

(51) Int. Cl. H01R 11/01; G06F 13/38; H01R 11/05; H01R 13/35

(52) U.S. Cl. CPC H01R 11/01; G06F 13/385; H01R 11/05; H01R 13/35; H01R 2201/06; H01R 2201/26

(57) ABSTRACT

Disclosed herein is a cable assembly configured to concurrently connect a smart phone device to a vehicle's media center and a fast charging device. The cable assembly is a singular design comprising a female USB type C connector for connection to a device such as a smart phone. The cable assembly then allows the smart phone to be concurrently connected to a vehicle's media system via a USB type A connection and to a fast charging device via a male USB type C connection. The USB type A connection transfers/receives data only while the male USB type C connection transfers power only.

### CROSS-REFERENCE TO RELATED PATENT APPLICATIONS

This application claims priority to U.S. Provisional Patent Application Ser. No. 63/094,782, filed Oct. 21, 2020.

### BACKGROUND OF THE INVENTION

### 1. Field of the Invention

Embodiments of the invention relate to an apparatus for fast charging a device while enabling the device to connect with a vehicle infotainment system.

### 2. Description of Related Art

Smart phones are ubiquitous and have become a central tool in managing an individual's work and life requirements. As a result, smart phones are constantly in daily use, which quickly drains the device's battery life. To address the device's quickly depleting battery life, the user may keep the device connected to a power source or use a fast charging device to quickly charge the device enabling the user to return to true mobile functionality.

Smart phone usage has expanded to nearly all aspects of one's life. The smart phone has been adapted for use while traveling in a vehicle, such as being used as a navigation tool, for their messaging capabilities, and other media programs. Because of these capabilities, today's vehicles allow an individual to view and control their smart phones through the vehicle's media center. This functionality is accomplished by connecting the smart phone to the vehicle's media center by way of a wired USB connection. The user can then use the vehicle's controls and voice controls to interact with their smart device through the vehicle's media center.

While connection to the vehicle's media center is a valuable resource for continuity in an individual's daily life, fast charging a device cannot be accomplished while connected to a vehicle's media system. The present invention addresses this limitation by providing an assembly allowing a user to connect to a vehicle's media system while simultaneously fast charging the smart phone device.

### BRIEF DESCRIPTION OF THE DRAWINGS

FIG. 1 shows a preferred embodiment of the cable assembly;

FIG. 2 shows an alternative embodiment of the cable assembly; and

FIGS. 3A & 3B show a further alternative embodiment of the cable assembly.

### DETAILED DESCRIPTION OF EMBODIMENTS

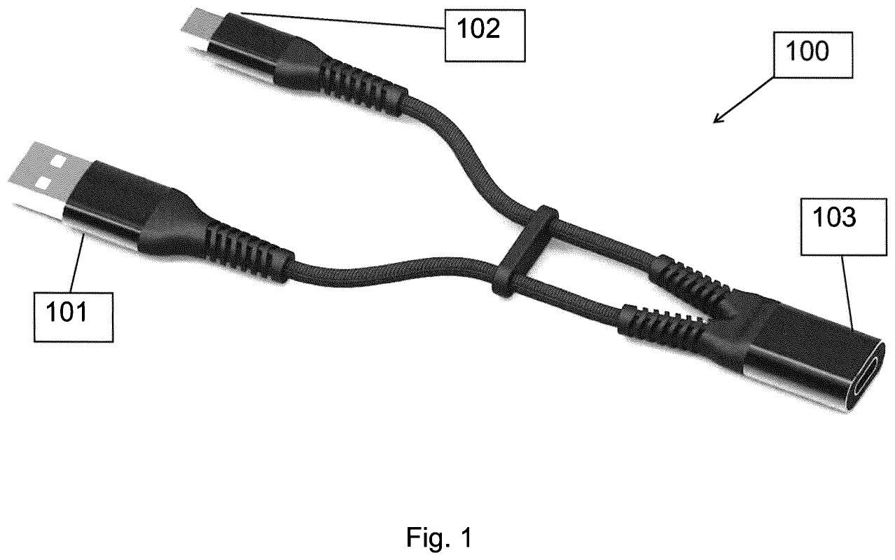

While the invention is illustrated and described in a preferred embodiment, the invention may be produced and described in many different configurations, forms and various methods, without deviating from the scope of the present invention. The preferred embodiment of the invention is described in detail below with reference to the accompanying FIGS. 1-3, with the understanding that the present disclosure is to be considered as an exemplification of the principles of the invention and the associated functional specifications for its construction and is not intended to limit the invention to the embodiment illustrated. For example, the inventive concepts apply equally to other connections, such as those associated with Apple® products including the lightning connection and the like. Moreover, although the embodiments describe connection to a smart phone device, it is to be understood that the embodiments contemplate connection to other devices capable of connection to a vehicle's media center. Those skilled in the art will envision many other possible variations within the scope of the invention described herein.

Referring now to FIG. 1 of a preferred embodiment, the present invention is a cable system 100 including at least three connection points—101, 102, and 103.

Connection 101 is for connecting to a vehicle's media center using for example a USB type A connector. Connection 101 is configured for the exchange of data only. As result, connection 101 has only 3 of four pins activated for the transfer of data. The fourth pin is disconnected to ensure no power flows to the smart phone device through connection 101. The maximum data rate for connection 101 at which data is transmitted and/or received is 480 Mbps.

Connection 102 is for connecting to a fast charging device. There are a number of fast charging devices available on the market and known to one of ordinary skill in the art.

Connection 102 may be a male USB type C connector. Connection 102 is for the transfer of power only. As result, connection 102 has only 10 of 24 pins activated for the transfer of power. The maximum current flowing through connection 102 is 3 amps. Moreover, for the purpose of fast charging the smart phone device, connection 102 has a range of 5V/1 A to about 20V/3 A where V is voltage and A is ampere.

Connection 103 is for connecting a smart phone device to a fast charging device and concurrently to a vehicle's media system. Connection 103 may be a female USB type C connector. Connection 103 facilitates the transfer of power to the smart phone device via the fast charge connection at 102 and the transfer of data with the vehicle's media system via connection 101. In this regard, a smart phone device, while connected to a vehicle's media system, can be fast charged and simultaneously allow the user to interact with the vehicle's media center through the smart phone device.

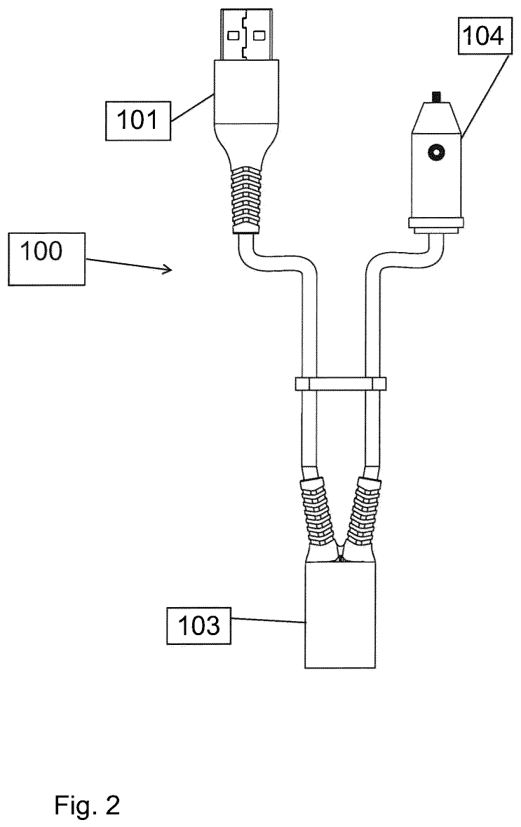

Referring now to FIG. 2, in an alternative embodiment, cable system 100 includes a fast charging male 12-24V car charger connection at 104 for connecting directly to a vehicle's power source. All other connections of cable system 100 in the alternative embodiment remain the same as described above with respect to FIG. 1.

In either FIG. 1 or 2, the cable system 100 is configured to be of a singular design. In this regard, cable system 100 is configured in a “Y” shaped configuration with the branches of the “Y” shaped design ending with connections 101 and 104 as in FIG. 2 or 101 and 102 in FIG. 1. The specific lengths of each branch is sufficient to enable connections to the vehicle's media system as well as facilitate fast charging the smart phone device. It is to be understood that the relative lengths may be configured based on a specific vehicle's design to accommodate the location of particular ports especially with respect to the alternative embodiment disclosed herein.

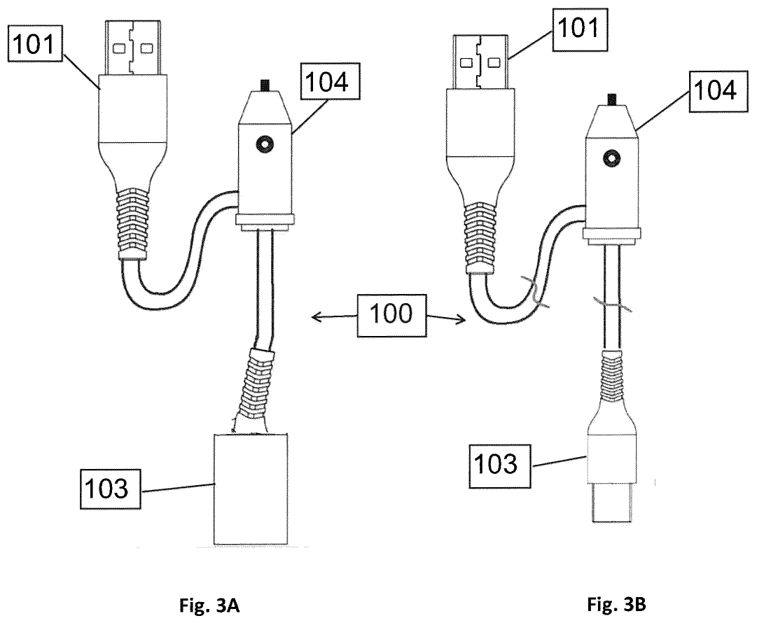

Referring now to FIGS. 3A and 3B, an alternative embodiment is disclosed. In this alternative embodiment, cable system 100 is configured in a linear design. As depicted in FIGS. 3A and 3B, there is no branch from connection 103, but rather a linear, in-line, configuration whereby connections 101, 104, and 103 are in-line in cable system 100. In addition, connection 103 may be a female USB type C connector, FIG. 3A, or a male USB type C connector, FIG. 3B. As with FIGS. 1 and 2, 101 is for only the transfer of data and 104 is for only the transfer of power to the device. The maximum data rate for connection 101 at which data is transmitted and/or received is 480 Mbps. In this embodiment, 104 is a fast charging male 12-24V car charger connection for connecting directly to a vehicle's power source.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

I claim:

1. A cable assembly for concurrently connecting a device to a media system and a fast charging source, comprising:
a device capable of connection to a media system allowing a user to exchange data and interact with the media system;
a first connection to the media system for the transfer of data between the device and the media system;
a second connection to a fast charging device for the transfer of power to the device; and
a third connection from the first and second connection to the device enabling the transfer of data and power to the device;
wherein the first, second, and third connections are interconnected in a cable assembly such that the device is simultaneously connected to the media system and a fast charging device.

2. The cable assembly of claim 1, wherein the first connection is a USB type A connector.

3. The cable assembly of claim 2, wherein the USB type A connector has only three of four pins activated for the transfer of data only to the device.

4. The cable assembly of claim 1, wherein the first connection has a maximum data rate at which data is transmitted and/or received of 480 Megabits per second.

5. The cable assembly of claim 1, wherein the second connection is a male USB type C connector.

6. The cable assembly of claim 5, wherein the male USB type C connector has only ten of twenty-four pins activated for the transfer of power only to the device.

7. The cable assembly of claim 1, wherein the maximum current flowing through the second connection is 3 Amps.

8. The cable assembly of claim 7, wherein the second connection has a range of SV/1 A to 20V/3 A.

9. The cable assembly of claim 1, wherein the third connection is a female USB type C connector.

10. The cable assembly of claim 1, wherein the cable assembly is in a branched configuration such that the first connection and the second connection branch from the third connection.

11. A cable assembly for concurrently connecting a device to a vehicle's media system and a fast charging source, comprising:
a device capable of connection to a vehicle's media system allowing a user to exchange data and interact with the vehicle's media system;
a first connection to the vehicle's media system for the transfer of data between the device and the vehicle's media system;
a second fast charging connection to a vehicle's power source for the transfer of power to the device; and
a third connection from the first and second connection to the device enabling the transfer of data and power to the device;
wherein the first, second, and third connections are interconnected in a cable assembly such that the device is simultaneously connected to the media system and a fast charging device.

12. The cable assembly of claim 11, wherein the first connection is a USB type A connector.

13. The cable assembly of claim 12, wherein the USB type A connector has only three of four pins activated for only the transfer of data to the device.

14. The cable assembly of claim 11, wherein the first connection has a maximum data rate at which data is transmitted and/or received of 480 Megabits per second.

15. The cable assembly of claim 11, wherein the second connection is a fast charging male 12-24V car charger connector.

16. The cable assembly of claim 11, wherein the third connection is a female USB type C connector.

17. The cable assembly of claim 11, wherein the third connection is a male USB type C connector.

18. The cable assembly of claim 11, wherein the cable assembly is in a branched configuration such that the first connection and the second connection branch from the third connection.
